(19) United States
(12) Patent Application Publication
(10) Pub. No.: US 2005/0131560 A1
(43) Pub. Date: Jun. 16, 2005

(54) Connection for audio transfer

(76) Inventors: Gek Hoon Quat, Singapore (SG); Lay Ling Neo, Singapore (SG); Hiap Chew Chua, Singapore (SG)

Correspondence Address: Stephen M. De Klerk;BLAKELY, SOKOLOFF, TAYLOR & ZAFMAN LLP, Seventh Floor, 12400 Wilshire Boulevard, Los Angeles, CA, 90025, US

(21) Appl. No.: 10/734,710

(22) Filed: Dec. 12, 2003

(51) Int. Cl. G06F 17/00; H04B 3/00

(52) U.S. Cl. 700/94; 381/77

(57) ABSTRACT

A connection for audio transfer, the connection comprising: (a) a first cable for operative connection to a first audio reproduction device, the first audio reproduction device including an audio player; (b) a first connector at an end of the first cable remote from the first audio reproduction device; (c) a second cable for operative connection to a second audio reproduction device; (d) a second connector at an end of the second cable remote from the second audio reproduction device; (e) the first connector being able to operatively connect with the second connector to enable audio transfer from the audio player to the second audio reproduction device, and to operatively connect with a host for audio transfer between the host and the audio player.

### FIELD OF THE INVENTION

This invention relates to a connection for audio transfer and refers particularly, though not exclusively, to a connection for audio download and reproduction; and to an audio reproduction device including such a connection.

### BACKGROUND TO THE INVENTION

In recent years many audio reproduction devices such as, for example, speakers and headphones, have integrated audio players. The audio player in each case may be, for example, an MP3 player. As such, the audio player will require a connection to a host device to enable the audio to be downloaded from the host device by the audio player. The host device may be a computer such as, for example, personal computer, laptop computer, notebook computer, tablet computer, personal digital assistant, and so forth.

To have a separate cable for downloading is quite often inconvenient. It has to be stored, carried, and protected from damage, when it may be required infrequently.

### SUMMARY OF THE INVENTION

In accordance with a preferred aspect of the invention there is provided a connection for audio transfer, the connection comprising:
(a) a first cable for operative connection to a first audio reproduction device, the first audio reproduction device including an audio player;
(b) a first connector at an end of the first cable remote from the first audio reproduction device;
(c) a second cable for operative connection to a second audio reproduction device;
(d) a second connector at an end of the second cable remote from the second audio reproduction device;
(e) the first connector being able to operatively connect with the second connector to enable audio transfer from the audio player to the second audio reproduction device, and to operatively connect with a host for audio transfer between the host and the audio player.

According to another aspect of the invention there is provided an audio reproduction device comprising:
(a) a first audio reproduction device including an audio player;
(b) a second audio reproduction device;
(c) a cable operatively connecting the first audio reproduction device and the second audio reproduction device;
(d) the cable being split into a first cable and a second cable with a first connector and a second connector respectively;
(e) the first connector being able to operatively connect with the second connector to enable audio transfer from the audio player to the second audio reproduction device, and to operatively connect with a host for audio transfer between the host and the audio player.

The audio player may be an MP3 player. The first and second audio reproduction devices may be an earpiece of a headphone set, or a speaker.

The first connector may be a male connector and the second connector may be a female connector. The first connector may be a USB connector and the second connector may be a USB port. Alternatively, the first connector may be an IEEE 1394 connector and the second connector may be an IEEE 1394 port.

The first connector may be a female connector and the second connector may be a male connector. The first connector may be a USB port and the second connector may be a USB connector. Alternatively, the first connector may be an IEEE 1394 port and the second connector may be an IEEE 1394 connector.

The host may be a computer. A controller may determine an operating mode based on a power supply detected. The operating mode may be one of: download, upload, and play; and the power supply may be one of: batteries, and power from the host.

### BRIEF DESCRIPTION OF THE DRAWINGS

In order that the invention may be readily understood and put into practical effect there shall now be described by way of non-limitative example only preferred embodiments of the present invention, the description being with reference to the accompanying illustrative drawings in which:

FIG. 1 is an exploded perspective view of a first embodiment in a first mode;

FIG. 2 an exploded perspective view of the first embodiment in a second mode;

FIG. 3 is a block diagram of the first embodiment; and

FIG. 4 is an exploded perspective view of a second embodiment in a first mode.

### DETAILED DESCRIPTION OF THE DRAWINGS

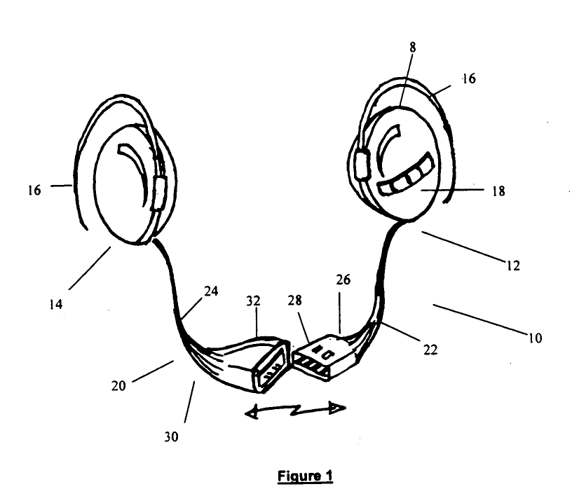

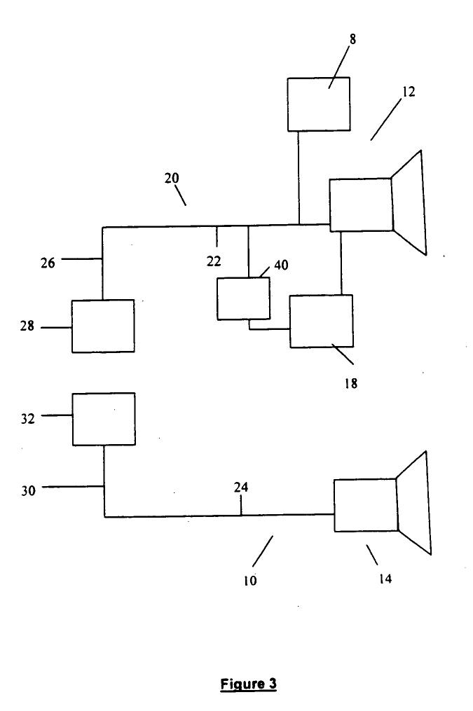

To first refer to FIGS. 1 and 3, there is shown an audio reproduction device in the form of a pair of headphones 10 in a first mode—reproduction of audio. The pair of headphones comprises a first earpiece 12 and a second earpiece 14. Each earpiece 12, 14 has a retaining member 16 to fit over and around an ear of a user. First earpiece 12 may also have control buttons 18 and a controller 40. Additionally or alternatively, control buttons 18 may also be on second earpiece 14.

Ear pieces 12, 14 may be attached to an arcuate body (not shown) for placement over or around a head of a user, if desired or required.

First earpiece 12 may incorporate a built-in audio player 8 such as, for example, an MP3 player. As such first earpiece 12 will have a source of power such as, for example, batteries; non-volatile memory; and a controller, as is well known in the art.

To enable audio to be sent from first earpiece 12 to second earpiece 14, a cable 20 is used. In this instance, the cable 20 is split into two separable portions and comprises a first cable 22 operatively connected to first earpiece 12 and a second cable 24 operatively connected to second earpiece 14. At its outer end 26—the end remote from first earpiece 12—the first cable 22 has a first connector 28. At its outer end 30—the end remote from second earpiece 14—the second cable 24 has a second connector 32. Connectors 28, 32 are for mutual engagement to enable audio to be sent from audio player 8 to second earpiece 14. Cables 22, 24 may be permanently connected to earpieces 12, 14; or may be releasably connectable to earpieces 12, 14 using appropriate connectors. Additionally, control signals from or between audio player 8, first earpiece 12 and second earpiece 14 may also pass over cable 20.

It is preferred that first connector 28 is a male connector, and second connector 32 is a female connector. More preferably first connector 28 is a USB connector, and second connector 32 is a USB socket. Alternatively, first connector 28 may be an IEEE 1394 connector, and second connector 32 may be an IEEE 1394 socket.

When connector 28 engages socket 32, audio can be transferred from first earpiece 12 to second earpiece 14.

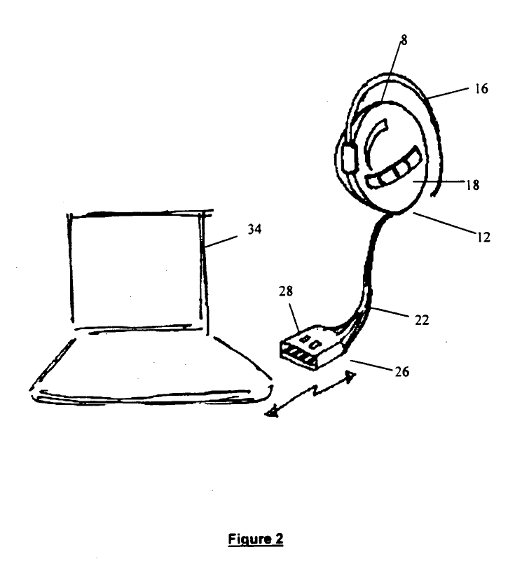

FIG. 2 shows headphones 10 in a second mode—audio download. Here, connector 28 has been disengaged from socket 32 and is about to engage in a corresponding socket (not shown) in computer 34 to enable audio to be downloaded and/or uploaded. Downloading and/or uploading may be from computer 34 to first earpiece 12, from first earpiece 12 to computer 34, or between first earpiece and computer 34 (one way or two way).

In this way, cable 22 with connector 28 acts as a download/upload cable/connector combination for audio player 8, as well as the cable/connector by which audio can be sent to second earpiece 14.

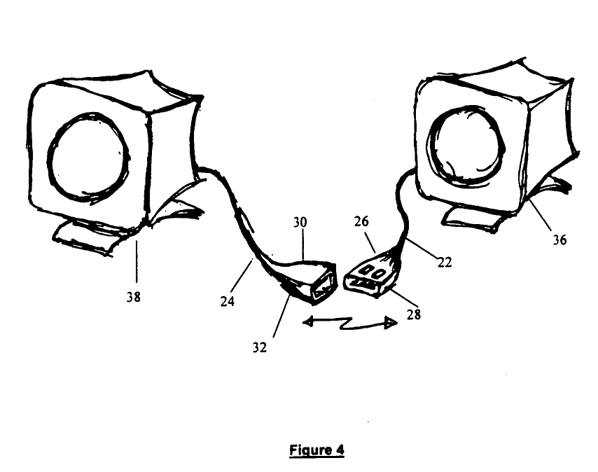

FIG. 4 shows a variation. Cable 22 is as for FIGS. 1 and 2 and has outer end 26 with connector 28; and cable 24 is also as for FIGS. 1 and 2 and has outer end 30 with socket 32. Here, however, the cables 22, 24 and connectors 28, 32 are to operatively connect two audio reproduction devices 36, 38 in the form of a first speaker 36 and a second speaker 38. First speaker 36 may also include an audio player 8 in the same way as first earpiece 12. First speaker 36 may also be battery powered and/or mains powered, and may include an amplifier.

Again, cable 22 and connector 28 may be used to upload and/or download audio to/from audio player 8, as is described above, as well as being for supplying audio to second speaker 38 to enable audio reproduction.

In this way cable 22 performs dual functions, thereby eliminating the need for a separate cable for downloading/uploading, as well as eliminating the need for the first audio device 12, 36 to have the relevant connectors for such a separate cable. The controller 40 determines the operating mode based on the power supply detected—batteries as against USB power.

Audio may be digital or analog.

Although two audio reproduction devices are shown in each instance, there may be any suitable or required number (particularly for speakers) such as, for example, 3, 4, 5 or 6.

Whilst there has been described in the foregoing description preferred embodiments of the present invention, it will be understood by those skilled in the technology that many variations or modifications in details of one or more of: design, construction and operation, without departing from the present invention.

1. A connection for audio transfer, the connection comprising:
(a) a first cable for operative connection to a first audio reproduction device, the first audio reproduction device including an audio player;
(b) a first connector at an end of the first cable remote from the first audio reproduction device;
(c) a second cable for operative connection to a second audio reproduction device;
(d) a second connector at an end of the second cable remote from the second audio reproduction device;
(e) the first connector being able to operatively connect with the second connector to enable audio transfer from the audio player to the second audio reproduction device, and to operatively connect with a host for audio transfer between the host and the audio player.

2. A connection for audio transfer as claimed in claim 1, wherein the audio player in an MP3 player.

3. A connection for audio transfer as claimed in claim 1, wherein the first and second audio reproduction devices are each selected from the group of: an earpiece of a headphone set, and a speaker.

4. A connection for audio transfer as claimed in claim 1, wherein the first connector is a male connector and the second connector is a female connector.

5. A connection for audio transfer as claimed in claim 1, wherein the first connector is a female connector and the second connector is a male connector.

6. A connection for audio transfer as claimed in claim 4, wherein the first connector is a USB connector and the second connector is a USB port.

7. A connection for audio transfer as claimed in claim 4, wherein the first connector is an IEEE 1394 connector and the second connector is an IEEE 1394 port.

8. A connection for audio transfer as claimed in claim 5, wherein the first connector is a USB port and the second connector is a USB connector.

9. A connection for audio transfer as claimed in claim 5, wherein the first connector is an IEEE 1394 port and the second connector is an IEEE 1394 connector.

10. A connection for audio transfer as claimed in claim 1, wherein the host is a computer.

11. A connection for audio transfer as claimed in claim 1, wherein a controller of the audio player determines an operating mode based on a power supply detected.

12. A connection for audio transfer as claimed in claim 11, wherein the operating mode is one of: download, upload, and play.

13. A connection for audio transfer as claimed in claim 11, wherein the power supply is one of: batteries, and power from the host.

14. An audio reproduction device comprising:
(a) a first audio reproduction device including an audio player;
(b) a second audio reproduction device;
(c) a cable operatively connecting the first audio reproduction device and the second audio reproduction device;
(d) the cable being split into a first cable and a second cable with a first connector and a second connector respectively;
(e) the first connector being able to operatively connect with the second connector to enable audio transfer from the audio player to the second audio reproduction device, and to operatively connect with a host for audio transfer between the host and the audio player.

15. An audio reproduction device as claimed in claim 14, wherein the audio player is an MP3 player.

16. An audio reproduction device as claimed in claim 14, wherein the first and second audio reproduction devices are each selected from the group consisting of: an earpiece of a headphone set, and a speaker.

17. An audio reproduction device as claimed in claim 14, wherein the first connector is a male connector and the second connector is a female connector.

18. An audio reproduction device as claimed in claim 14, wherein the first connector is a female connector and the second connector is a male connector.

19. An audio reproduction device as claimed in claim 17, wherein the first connector is a USB connector and the second connector is a USB port.

20. An audio reproduction device as claimed in claim 17, wherein the first connector is an IEEE 1394 connector and the second connector is an IEEE 1394 port.

21. An audio reproduction device as claimed in claim 18, wherein the first connector is a USB port and the second connector is a USB connector.

22. An audio reproduction device as claimed in claim 18, wherein the first connector is an IEEE 1394 port and the second connector is an IEEE 1394 connector.

23. An audio reproduction device as claimed in claim 15, wherein the first and second audio reproduction devices are each selected from the group consisting of: an earpiece of a headphone set, and a speaker.

24. An audio reproduction device as claimed in claim 14, wherein the host is a computer.

25. An audio reproduction device as claimed in claim 14, wherein a controller determines an operating mode based on a power supply detected.

26. An audio reproduction device as claimed in claim 25, wherein the operating mode is one of: download, upload, and play.

27. An audio reproduction device as claimed in claim 25, wherein the power supply is one of: batteries, and power from the host.
